(19) United States
(12) Patent Application Publication
(10) Pub. No.: US 2022/0323892 A1
(43) Pub. Date: Oct. 13, 2022

(54) ENERGY-SAVING AND ENVIRONMENTALLY FRIENDLY FILTER AND METHOD FOR PRODUCING THEREOF

(71) Applicant: ZHEJIANG LONGYOU FILTER MANUFACTURING CO., LTD, Qauzhou, Zhejiang (CN)

(72) Inventor: Guohua YANG, Quzhou City, Zhejiang Province (CN)

(21) Appl. No.: 17/615,841

(22) PCT Filed: May 30, 2020
(86) PCT No.: PCT/CN2020/093558

§ 371 Date: Dec. 2, 2021

(30) Foreign Application Priority Data
Apr. 21, 2020 (CN) 202010314766.2

(51) Int. Cl. B01D 46/00; B01D 46/52; F02M 35/024; F16B 11/00

(52) U.S. Cl. CPC B01D 46/0001; B01D 46/521; F02M 35/02441; F02M 35/02408; F16B 11/006; B01D 2265/04

(57) ABSTRACT

The present disclosure relates to an energy-saving and environmentally friendly filter and a method for producing thereof. The energy-saving and environmentally friendly filter includes filter element body composed of a plurality of sections of bending parts, including a sealing part is arranged on the bending part and configured to block the bending part. The advantage of the present disclosure is that the large amount of air intake per unit time improves the combustion efficiency of the internal combustion engine fuel and makes the power more abundant.

### TECHNICAL FIELD

The present disclosure relates to technical field of filter element, in particular to an energy-saving and environmentally friendly filter and method for producing thereof.

### BACKGROUND

At present, no matter what automobiles or other construction machines in the world, as long as they belong to the “internal combustion engine”, they all need filters (e.g., air filter element).

Air filter element is a filter. Taking the existing “cylindrical” air filter element, as an example, in order to ensure its service life, in current the bending device (e.g. bending machine) is used to make several consecutive folds according to the stated height and folding distance at the time of production, and then with the help, of clamping devices (e.g., strip clamping machine), the two ends are clamped with metal clamping strips to form a closed loop. Finally, placing the closed loop between the outer net and the inner net that have been formed, and the two ends are sealed and glued with end covers and glue.

However, the air filter element has a common feature, that is, the filter material constituting the whole filtering area of the air filter element is breathable. When this type of air filter element is used in internal combustion engines, there are still some deficiencies as follows:

Firstly, long-time low-speed (idle) operation is easy to cause engine carbon deposition;

Secondly, some engines will cause engine oil increase and emulsification due to insufficient combustion;

Thirdly, sonic turbocharged engines burn too much oil seriously;

The above three deficiencies will directly lead to the lack of power of the internal combustion engine, such that the discharge can not reach “the exhaust pollution control standard”, according to this, there is an urgent demand to provide an energy-saving and environmentally friendly filter to solve the above problems.

### SUMMARY

In view of the deficiencies of the prior art, the present disclosure aims to provide an energy-saving and environment-friendly filter and a production method thereof, aiming to solve the problems mentioned above.

The technical solution, of the present disclosure is realized in this way the energy-saving and environmentally friendly filter includes a filter element body composed of a plurality of sections of bending parts, wherein a sealing part is arranged on the bending part and configured to block the bending part.

Preferably, the sealing part is located at a bend portion of the bending part.

Preferably, the sealing part is glue.

Preferably, the sealing part is made of metal.

In addition, the present disclosure also provides a production method of the energy-saving and environmental protection filter, which is suitable for producing the energy-saving and environmental protection air filter element mentioned above, the method includes the following steps:

S1: preparing filter material;

S2: using a bending machine to bend the filter material, so as to form bending part;

S3: applying glue to a bend portion of the bending part;

S4: fixing two ends of the filter material by a strip clamping machine to form a closed loop;

S5: putting the filter material in step S4 between an outer net and an inner net and fixing end covers with the two both ends of the filter material by the glue to, complete the production,

The advantage of the present disclosure is shown below:

By providing the sealing part (e.g., glue) to block the bending part. For example, the glue can be applied to the bend portion of the bending part and evenly applied along the inner wall and height direction of the bending part. When sonic portions of the bending part is blocked, the pressure loss of the air filter element during operation will be reduced, and the air pressure on the most unblocked part will increase, the air flow rate will also increase, which can improve the air flow and make the engine fuel burn more fully, so as to improve the engine power and achieve the effect of energy conservation and emission reduction (i.e., reducing engine carbon deposition and oil abnormal').

### BRIEF DESCRIPTION OF THE DRAWINGS

To more clearly illustrate the embodiment of the present disclosure or technical solutions of prior art, the following will briefly introduce the drawings needed to be used in the embodiment or prior art description. It is obviously that the drawings in the following description are only some embodiments of the present disclosure. For those skilled in the art, other drawings can be obtained from these drawings without paying creative labor.

FIG. 1 is a schematic diagram of the cross-sectional structure of embodiment 1 of the present disclosure;

FIG. 2 is a schematic diagram of the cross-sectional structure of the prior art.

FIG. 3 is a structural schematic diagram of some portions of the bending part in embodiment 1 of the present disclosure;

FIG. 4 is a fuel saving curve tested in the present embodiment.

### DETAILED DESCRIPTION OF THE EMBODIMENTS

The following will be combined with the drawings in the embodiment of the present disclosure, the technical solution in the embodiment of the disclosure will be clearly and completely described. It is appearant that the described embodiments are only part of the embodiments of the present disclosure, not all of them. Based on the embodiments in the present disclosure, all, other embodiments obtained without creative labor by those skilled in the art belong to the scope of the present disclosure.

### Embodiment 1

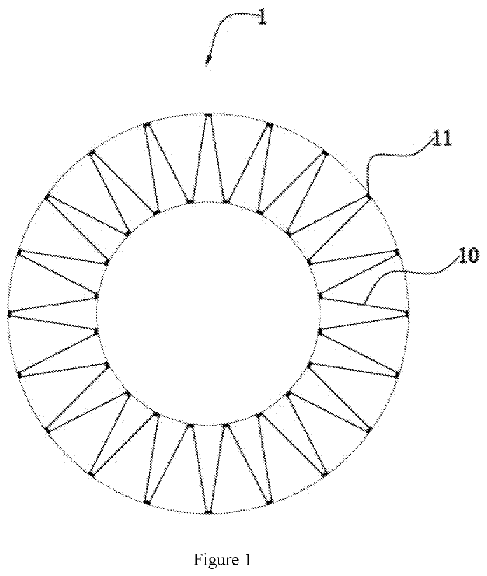

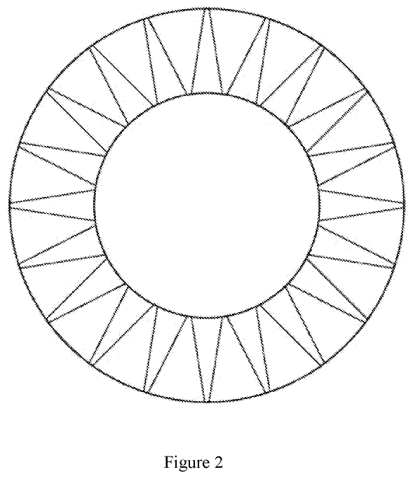

As shown in FIGS. 1-4, the present disclosure discloses an energy-saving and environmentally friendly filter, which includes a filter element body I composed of several sections of bending parts 10. In the specific embodiment of the present disclosure, the energy-saving and environmentally friendly filter includes sealing part 11 arranged on the bending, part 10 and used to block the bending part 10.

In the specific embodiment of the present disclosure, the sealing part 11 is located at the bend portion of the bending part.

In the specific embodiment of the present disclosure, the sealing part 11 is glue.

The present disclosure also provides a production method of energy-saving and environmental protection filter, which is suitable for producing the energy-saving and environmental protection air filter element described above, and the method includes the following steps:

S1: preparing filter material;

S2: using a bending machine to bend the filter material and form bending part;

S3: applying glue to the bend portion of the bending part;

S4: fixing the two ends of the filter material are fixed by a strip clamping machine to form a closed loop;

S5: putting the filter material in step S4 between the outer net and the inner net and fixing the end covers with the both ends of the filter material by glue to complete the production.

The principle of the embodiment is:

According to the gas flow rate formula Q=V*S (V is the flow rate, S is the cross-sectional area that the gas flow passed), the flow rate V is direct proportion to the pressure difference P between the front and the back of the gas passing through the air filter element (the pressure difference P is actually equal to the resistance of the filter material P_{resistance}), because the cross-sectional area S is direct proportion to the length L of the bending part. Therefore, the flow calculation formula can be simplified as Q=P_{resistance}*L.

### EXAMPLE

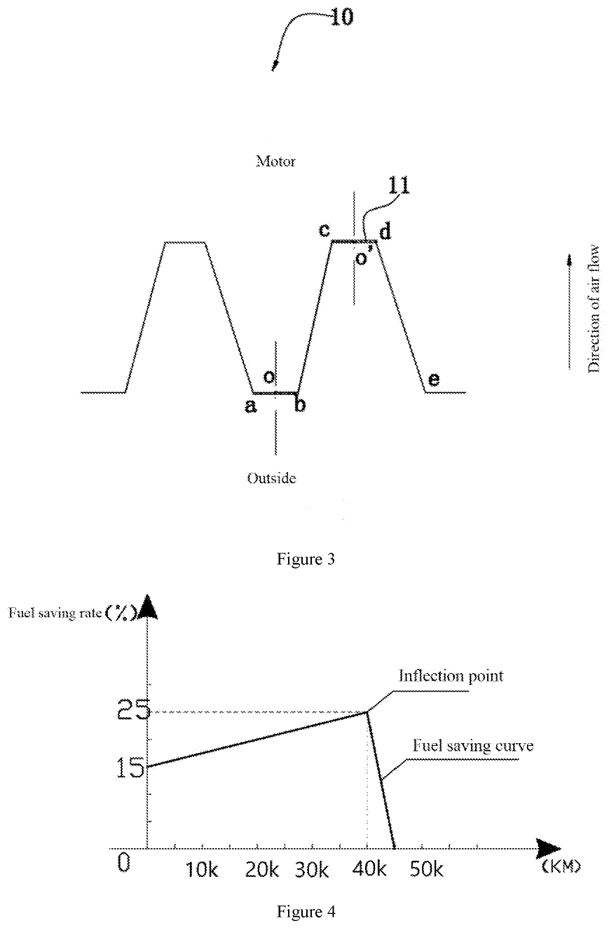

Referring to FIG. 3, it is assumed that be (de) is 40 mm and ab (cd) of the bend portion is 1 mm, at the same time, it is assumed that the resistance on the whole half folded filter material at the bend portion obco′ is P_{resistance}. Taking obco′ half fold as an example, due to the blockage of the bend portion, the lost flow Qₗₒₛₛ=(ob+co′) P_{resistance}=(0.5+0.5) P_{resistance}=P_{resistance}. At the same time, due to the blockage of the bend portion, the pressure loss of air through the bending part is prevented. Moreover, since ob, be and co′ are no longer on the same working surface after a certain proportion of bending, the force on the be surface of the filter material will increase 2P_{resistance} (because the P_{resistance} of the same section ab will increase the P_{resistance} of be and de respectively), in other words, the flow will increase by Q_{increase}=80*P_{resistance}, at least 80 times the lost flow. Therefore, when the bend portion of the bending part is blocked, the intake pressure of the rest portion of the bending part (i.e. bc) will increase, at the same time, the air velocity will also increase. Because the blockage at the bend portion is very small area, the amount of air entering the engine per unit time will increase, so as to improve the combustion efficiency of fuel and achieve the effect of energy conservation and emission reduction.

Practice results of the embodiment:

There are four types of test vehicles (naturally aspirated diesel vehicle, turbocharged diesel vehicle, naturally aspirated gasoline vehicle and turbocharged gasoline vehicle), the summary has the following conclusions:

The fuel saving rate (average) is grater than 15%, and when the filter element is new, it is not the best time to save fuel, refer to FIG .4 for specific oil saving variation;

Fuel saving life (paved, roads), cylindrical air filter≥40,000 km, the effective utilization rate of the filter material is significantly increased;

For the oil burned engine, the burden of turbocharger is reduced and the oil burning situation is obviously improved after using;

The phenomenon of engine oil increase and emulsification caused by insufficient combustion is completely cured due to more sufficient combustion after using;

Due to the large intake volume and sufficient combustion, less fuel is consumed at the same speed, so as to optimize emission data;

Due to the large intake volume and sufficient combustion, the phenomenon of carbon deposition at low speed (idle speed) is completely overcome;

Due to the large intake volume and sufficient combustion, the power is significantly improved and throttle response is more rapid, and the vehicle handling is improved to a higher level.

The above fuel saving effect with a fuel saving rate greater than 15% is mainly due to the following reasons:

Large air intake volume, sufficient combustion and power improvement;

Due to sufficient combustion, the engine throttle valve is not easy to deposit carbon and the cylinder is well sealed, the above two factors are superimposed to make the fuel saving effect greater than 15%.

The following is an analysis of why the fuel saving curve of the air filter made by the innovative bending method appears as shown in FIG. 4 (the more used it, the better the trend). As we all know, the air filter element works through negative pressure suction, and the maximum negative pressure is 1 atmospheric pressure. When an air filter element is made of a certain amount of filter material, its basic flow is determined, and there is a certain distance between the air filter element and the engine cylinder. And because the time to open and close of the engine throttle valve at a certain speed are fixed, when the base flow of the filter element at a certain stage are greater than the engine displacement, as the dust continues to accumulate on the air filter, the air filter resistance increases, such that the flow rate increases. Therefore, at this stage, the amount of air entering the engine cylinder increases with the increase of air filter resistance (the more use, the better). As time goes by, the effective aperture of the air filter decreases, when the base flow rate drops to less than or equal to the engine displacement, there is an “inflection point” shown in FIG. 4.

The existing air filter element has a large pressure loss due to the ventilation of the full filtration area, therefore, the more it is used, the worse it becomes.

It is worth mentioning that this embodiment is not only applicable to gas filtration, but also applicable to the fields of liquid filtration, gas-liquid separation and liquid-liquid separation.

Embodiment 2, the differences between the embodiment 1 and the embodiment 2 is that:

In specific embodiment of the present disclosure, the sealing part 11 is made of metal.

By using the above technical solution: the sealing effect of metal (for example, iron sheet) will be better than that of glue.

The above is only a preferred embodiment of the disclosure and is not intended to limit the disclosure. Any modification, equivalent substitution, improvement, etc. made within the spirit and principles of the disclosure shall be included in the scope of the disclosure.

What is claimed is:

1. An energy-saving and environmentally friendly filter, comprising a filter element body composed of a plurality of sections of bending parts, wherein a sealing part is arranged on the bending part and configured to block the bending part.

2. The energy-saving and environmentally friendly filter according to claim wherein the sealing part is located at a bend portion of the bending part.

3. The energy-saving and environmentally friendly filter according to claim 1, wherein the sealing part is glue.

4. The energy-saving and environmentally friendly filter according to claim 1, wherein the sealing part is made of metal.

5. A method for producing of an energy-saving and environmentally friendly filter, which is suitable for producing the energy-saving and environment-friendly air filter element according to claim 1, the method comprises the following the steps:
S1: preparing filter material;
S2: using a bending machine to bend the filter material, so as to form a bending part;
S3: applying glue to a bend portion of the bending part;
S4: fixing two ends of the filter material by a strip clamping machine to form a closed loop;
S5: putting the filter material in step S4 between an outer net and an inner net and fixing end covers with the two ends of the filter material by the glue to complete the production.

6. The energy-saving and environmentally friendly filter according to claim 2, wherein the sealing part is glue.

7. The energy-saving and environmentally friendly filter according to claim 2, wherein the sealing part is made of metal.
